(19) United States
(12) Patent Application Publication
(10) Pub. No.: US 2026/0177217 A1
(43) Pub. Date: Jun. 25, 2026

(54) METHOD FOR MANUFACTURING A VEHICLE PART COMPRISING A TRANSPARENT OR TRANSLUCENT PORTION

(71) Applicant: OPmobility SE, Lyon (FR)

(72) Inventor: Gérald ANDRE, SAINTE-JULIE (FR)

(21) Appl. No.: 19/430,597

(22) Filed: Dec. 23, 2025

(30) Foreign Application Priority Data
Dec. 26, 2024 (FR) FR2415301

(51) Int. Cl. F21S 41/20; B05D 1/32; B05D 3/00; B05D 3/06; B05D 7/02; F21S 43/20

(52) U.S. Cl. CPC F21S 41/285; B05D 1/32; B05D 3/007; B05D 3/06; B05D 7/02; F21S 43/265; B05D 2201/02; F21S 2243/00

(57) ABSTRACT

A method for manufacturing a vehicle part including masking a portion of a transparent or translucent vehicle part body, so as to form a masked portion of the part body; applying a coat of paint to the part body, in an area encompassing all or part of the masked portion, so as to form a painted area;

removing the masking, the masked portion becoming an unmasked, paint-free portion; and irradiating the coat of paint with laser radiation, in a border of the unmasked portion, so as to define a clear paint boundary around the unmasked portion.

### TECHNICAL FIELD

The present invention relates to a method for manufacturing a vehicle part, in particular for use in applications requiring transparent or translucent areas. The invention also relates to a vehicle part, a luminous component for a motor vehicle and a motor vehicle.

### BACKGROUND

A vehicle comprises several transparent parts designed to transmit light. These include, in particular, parts used for light signaling or regulatory lighting purposes, such as those protecting the headlamp units of high and low beam headlamps, or turn signal lights. Moreover, the vehicle can also feature light sources for decorative purposes that enhance the aesthetics of the vehicle.

One of the desires of car manufacturer styling teams is, in particular, to be able to integrate lighting or light signaling areas into a painted body part, without interface play or the effect of a patch. However, these areas must comply with regulatory photometric standards, particularly in terms of transmitted light intensity. To achieve this, for certain lighting or signaling functions in particular, transparent or translucent materials used in the part in question must not transmit light that is too diffused in relation to the intensity levels required by regulations, to avoid too much light power being required to compensate for the diffusion.

The problem is therefore to be able to paint a vehicle part while preserving an area of transparency or translucency on the same part, allowing light emitted by a light source to be transmitted, in compliance with regulatory photometric standards.

In the state of the art, in particular the method described in document FR3095620, a masking method is known, consisting in applying a temporary adhesive to a portion of the part, with the aim of masking this portion. The next step is to apply a coat of paint to the part, then remove the masking. The unmasked portion forms the transparent or translucent portion of the part, allowing light to be transmitted.

This method does not alter the optical properties of the unmasked portion and, in particular, does not increase the diffused nature of the transmitted light, so that it is possible to transmit light that complies with regulatory standards, provided the chosen material is suitable.

However, after the masking has been removed, the border of the unmasked area, forming the boundary between the painted and unmasked areas, is often unclear, unsightly and may show adhesion losses, which is not acceptable. For this reason, the masking method is more often used when the unpainted area to be masked has a style line, such as a gouge or edge line, which also provides a visual delimitation with respect to the painted portion of the part. This style line helps to implement the method, in particular to apply the adhesive at the start of the method, and then to hide any defects in the result in or behind the relief of the style line.

An alternative laser irradiation method is known, in particular from the same document FR3095620. Once the coat of paint has been applied, laser irradiation is applied to the portion of the part to be made transparent or translucent, to remove the paint from this portion. This method makes it possible to define a clear, aesthetic and adherent boundary between a painted area of the part and a paint-free area.

However, laser irradiation can modify the surface of the part, making the light passing through the part particularly diffuse. In this case, the method makes it difficult to comply with regulatory photometric standards for equivalent light sources. The irradiation method is also more time-consuming than the masking method, particularly when a large illuminating surface is required to comply with a regulatory standard.

It should be noted that these two methods are known to a person skilled in the art as purely alternative solutions to one another, as is the case in document FR3095620. This is because they use two completely different technologies for the same purpose, and generate defects which, at first glance, are likely to be cumulative, which does not encourage a skilled person to imagine a complementary use.

One particular aim of the invention is to make a lighting area appear on a vehicle part without any play or patch effect and avoiding the disadvantages of the two above-mentioned methods as much as possible.

### SUMMARY OF THE INVENTION

The present invention aims to overcome these limitations by providing a method for manufacturing a vehicle part, comprising the following steps:
masking a portion of a transparent or translucent vehicle part body, so as to form a masked portion of the part body;
applying a coat of paint to the part body, in an area encompassing all or part of the masked portion, so as to form a painted area;
removing the masking, the masked portion becoming an unmasked, paint-free portion;
irradiating the coat of paint with laser radiation, in a border of the unmasked portion, so as to define a clear paint boundary around the unmasked portion.

In this way, the invention exploits the advantages of both prior art methods and minimizes their respective disadvantages. In particular, laser irradiation is applied only to the border of the unmasked portion and not to the entire portion of the part intended to be transparent or translucent. The method is therefore both fast, by only targeting the border with laser irradiation, longer than the masking method, and achieves a satisfactory result both in terms of light transmission through the area that was masked and in terms of the aesthetic quality of the border of this area, by virtue of the laser irradiation method.

Other optional features follow hereinbelow, taken either alone or in combination.

Preferably, the method comprises a step of manufacturing the body of the transparent or translucent part by molding a plastic, e.g., polycarbonate, polyamide, polyethylene terephthalate, polybutylene terephthalate, polyurethane, polyvinyl chloride, acrylonitrile butadiene styrene, styrene acrilonitrile, acrylonitrile styrene acrylate, polymethyl methacrylate, cycloolefin copolymer or cycloolefin polymer.

Advantageously, the plastic is a transparent or translucent polypropylene.

In fact, this material is particularly suitable for the manufacture of body parts exposed to deformation stress and small impacts, in particular large parts. However, it is also possible to make it translucent or transparent, and thus to form luminous components for vehicles. However, its surface is altered during laser irradiation, modifying the transparency and diffusion of light passing through the material. Thus, the method according to the invention makes it possible to benefit from the advantages linked to the use of transparent or translucent polypropylene for the production of at least one portion of a transparent or translucent vehicle part, while avoiding, by confining laser irradiation to a border, a greater part of the disadvantages linked to the implementation of an irradiation step with laser radiation.

Preferably, the irradiation step further comprises irradiating a portion of the painted area from the clear paint boundary, so as to form an intermediate area located between the unmasked portion and the rest of the painted area.

In this way, the method allows an intermediate area to be formed between a transparent or translucent area, without altering the surface, and a painted area, with or without altering the surface depending on the material forming the part. This intermediate area allows light to pass through, but may have different photometric characteristics from those of the transparent or translucent area, so as to generate aesthetic effects and/or a transition effect between the transparent or translucent area and the painted area.

Advantageously, the irradiation step is carried out in such a way as to form one or more specific patterns in the intermediate area, e.g. hatching

As a result, the intermediate area features one or more aesthetically pleasing patterns. The irradiation step offers a wide range of aesthetic choices.

Advantageously:
the masking step comprises placing a temporary covering means,
the step of applying the coat of paint comprises applying an opaque, preferably dark, adhesion primer and applying a base coat in a predetermined shade.

Preferably, the method further comprises applying a coat of varnish to the part.

Advantageously, a coat of varnish is applied after the laser irradiation step.

The invention also relates to a vehicle part obtained by the manufacturing method as set out above, comprising:
a transparent or translucent portion formed by the unmasked portion;
a painted portion formed by the painted area.

Advantageously, the part also comprises an intermediate portion formed by the intermediate area between the transparent or translucent portion and the painted portion.

Preferably, the transparent or translucent portion has a haze coefficient value at least 10% lower than the haze coefficient value of the intermediate area, preferably at least 20% lower, more preferably at least 30% lower.

This haze coefficient corresponds to the coefficient of haze known to a person skilled in the art. It can also be defined as the ratio of diffuse light transmission to total light transmission.

In this way, the intermediate portion is a transition area that can be illuminated, but is mainly for aesthetic purposes.

The invention also relates to a luminous component for a motor vehicle, comprising a part as previously stated and a light source for illuminating at least part of the transparent or translucent portion of the part.

Preferably, this luminous component forms one of the following elements:
a daytime running light;
a position light;
a turn signal;
a reversing light;
a headlamp

The invention also relates to a motor vehicle comprising at least one part as described above and/or at least one luminous component as described above.

Also described is a vehicle exterior component having a main surface, comprising the part as previously stated, corresponding to at least twice the surface area of the part, the exterior component forming, for example, a bumper, grille, fender, rear spoiler, hood or tailgate panel.

Advantageously, the vehicle part comprises a plurality of materials.

### BRIEF DESCRIPTION OF THE FIGURES

The invention will be better understood upon reading the following description, which is provided merely by way of example and with reference to the appended drawings, in which:

FIG. 1 is a flowchart of a method for manufacturing a vehicle part according to a first embodiment of the invention;

FIG. 2 is a cross-sectional view of a vehicle part in the manufacturing method of FIG. 1, according to the first embodiment;

FIG. 3 is a cross-sectional view of a vehicle part as part of the manufacturing method;

FIG. 4 is a cross-sectional view of a vehicle part as part of the manufacturing method;

FIG. 5 is a cross-sectional view of a vehicle part as part of the manufacturing method;

FIG. 6 is a cross-sectional view of a vehicle part as part of the manufacturing method;

FIG. 7 is a cross-sectional view of a vehicle part as part of the manufacturing method;

FIG. 8 shows a front view of the resulting part;

FIG. 9 is a view of a vehicle comprising the part obtained;

FIG. 10 is a flowchart of a method for manufacturing a vehicle part according to a second embodiment of the invention;

FIG. 11 is a cross-sectional view of a vehicle part in the manufacturing method of FIG. 10, according to the second embodiment;

FIG. 12 is a front view of the part obtained by the second embodiment;

FIG. 13 is a view of a vehicle comprising the part obtained by the second embodiment;

FIG. 14 is a cross-sectional view of a vehicle part obtained by a variant of the method shown in FIG. 10.

### DETAILED DESCRIPTION

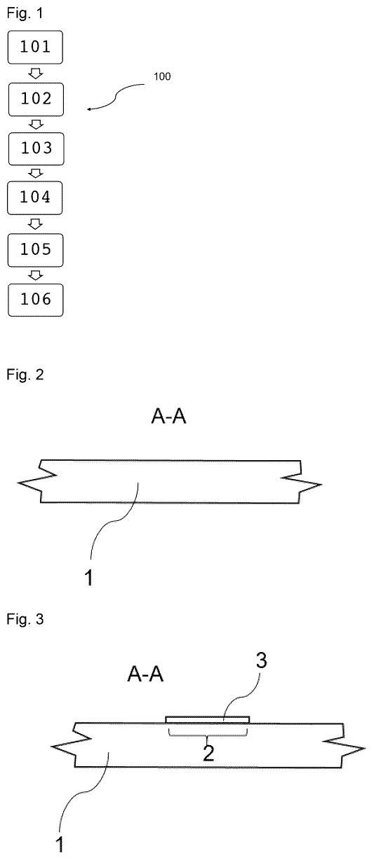

With reference to FIGS. 1 to 8, a method 100 for manufacturing a vehicle part 11 is described below. In particular, according to the present embodiment, it is envisaged that the vehicle part 11 is a vehicle body part. According to other embodiments, the vehicle part may be a part other than a body part. This method is implemented by means known to a person skilled in the art and which are not the object of the invention.

In step 101, a vehicle body part body 1 is obtained by molding, preferably injection-molding, transparent or translucent polycarbonate.

“Transparent” is defined as a material with a transparency level greater than or equal to 80% and a haze coefficient less than or equal to 30%. “Translucent” is defined as a material with a transparency level of between 20% and 80%, and a haze coefficient of between 30% and 90%. For the purposes of the invention, a “transparent or translucent” material therefore has a transparency level of at least 20% and a haze coefficient of less than or equal to 90%. “Haze coefficient” refers to the “coefficient of haze”, known to a person skilled in the art. It can also be defined as the ratio of diffuse light transmission to total light transmission.

In step 102, a portion 2 of the part body 1 is masked so as to cover this masked portion 2 of the part. This masking involves placing a temporary covering means 3 over the portion 2, as shown in FIG. 3.

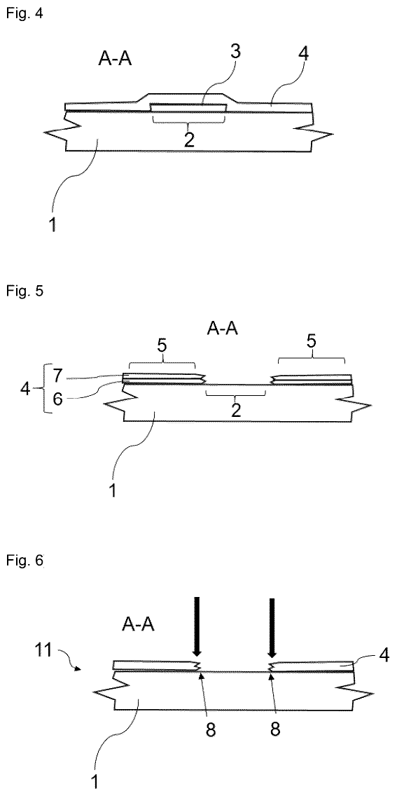

In step 103, a coat 4 of paint is applied to the part body 1, in an area encompassing the entire masked portion 2, so as to form a painted area as shown in FIG. 4. According to the present embodiment, applying the coat 4 of paint comprises applying an opaque, dark adhesion primer 6 and applying a base coat 7 in a predetermined shade. These elements are shown in FIG. 5.

In a variant not shown, other choices of primer 6 and base coat 7 are made.

In a variant not shown, only one coat is applied: the paint is single-coat. For example, it is a single coat that is opaque to light. In particular, it can be a lacquer. It can also be a single-coat finish with the aesthetic equivalent of a base and varnish combination. Such a single coat can also be combined with a primer.

Conversely, in another variant, not shown, a plurality of coats are applied successively.

In a variant not shown, the painted area encompasses only part of the masked portion 2. This saves paint, for example in the center of the masked portion.

In step 104, the masking is removed, with the masked portion 2 becoming an unmasked, paint-free portion 2, as shown in FIG. 5.

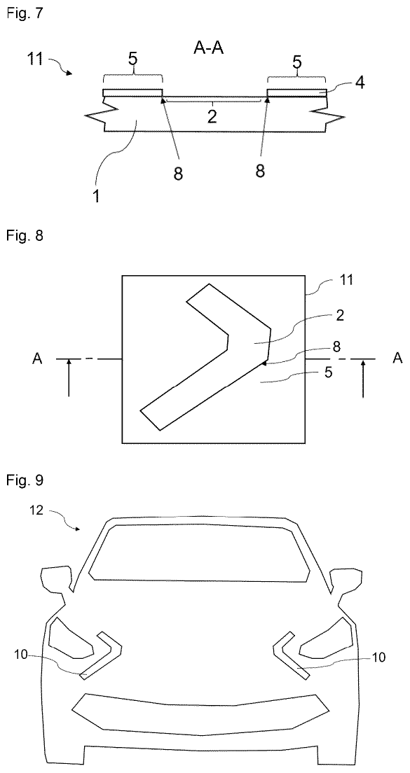

In step 105, the coat 4 of paint is irradiated with laser radiation, in a border 8 of the unmasked portion 2, so as to define a clear paint boundary around the unmasked portion 2, as shown in FIG. 6.

For the sake of simplicity, with the exception of FIG. 5, the coat 4 of paint is shown in a single coat, with no distinction between the adhesion primer coat 6 and the base coat 7. Of course, as already indicated, the composition of the coat 4 of paint can vary according to the application, and can in particular be single-coat.

In step 106, a coat of varnish (not shown) is applied to the part.

This method 100 produces a vehicle part 1 comprising:
a transparent or translucent portion formed by the unmasked portion 2;
a painted portion formed by the painted area 5.

These transparent or translucent and painted portions are separated by a clear paint boundary.

The resulting part 11 is also shown in front view in FIG. 8.

In a variant not shown, the irradiation step extends into the painted area 5. Since laser irradiation does not significantly alter the polycarbonate surface, the transparency and diffusion of light passing through an irradiated area is no different from that passing through the transparent or translucent portion 2. Thus, extending irradiation into the painted area is equivalent, in this embodiment, to replacing part of the painted portion 5 with an extension of the transparent or translucent portion 2.

FIG. 9 shows a vehicle 12 comprising two luminous components 10 for a motor vehicle. These luminous components 10 comprise the vehicle part 11. A light source, not shown, is located inside the vehicle, opposite each part 11, so as to emit the light that will pass through the transparent or translucent portion 2.

Depending on the intended functionality, these luminous components 10 can be one of the following:
a daytime running light;
a position light;
a turn signal;
a reversing light; or
a headlamp.

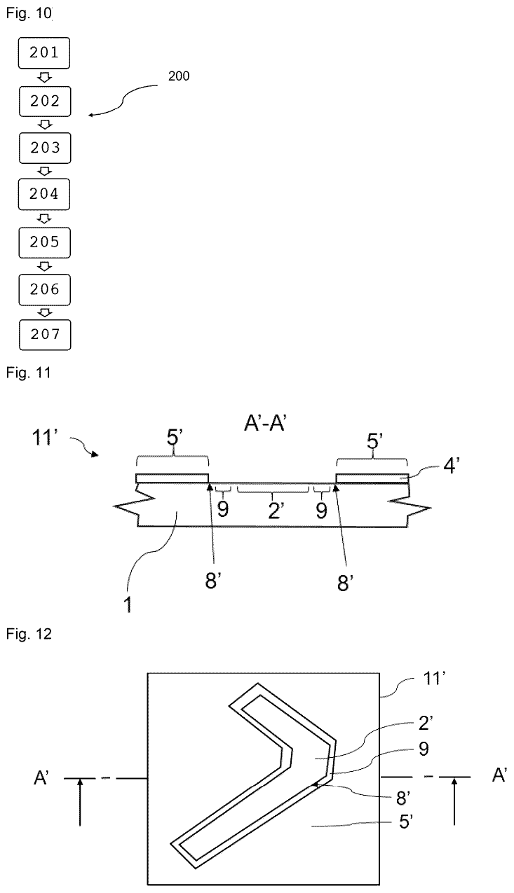

A second embodiment of the manufacturing method, referenced 200 and shown in FIG. 10, is described below.

In step 201, a vehicle body part body 1 is obtained, this time by molding, preferably injection-molding, transparent or translucent polypropylene.

Steps 202 to 206 are similar to steps 102 to 106.

The resulting part is shown in FIGS. 11 and 12. Numerical references corresponding to elements similar to those of the previous embodiment are provided with an apostrophe to differentiate this part from the one obtained by the method 100.

The irradiation step 207, added with respect to the method 100, further comprises irradiating a portion of the painted area 5′from the clear paint boundary of the border 8′, so as to form an intermediate area 9 located between the unmasked portion 2′ and the remainder of the painted area 5′.

This method 200 thus produces a vehicle part 11′ comprising:
a transparent or translucent portion formed by the unmasked portion 2′;
a painted portion formed by the painted area 5′;
an intermediate portion formed by the intermediate area 9, between the transparent or translucent portion 2′ and the painted portion 5′.

The light passing through the irradiated intermediate portion 9 is more diffuse and of lower light intensity than that passing through the transparent portion 2 of the part 11 obtained by the method 100, due to the laser irradiation of the intermediate area 9. In particular, irradiation of the painted area of the polypropylene generates the presence of a residue layer, which is not thick, and/or an alteration in the optical properties of the polypropylene surface.

This difference in transparency and diffusion creates an aesthetic and transitional effect between the portion 2′ and the portion 5′. It is advantageous, from an aesthetic point of view, that the transparent or translucent portion 2′ has a haze coefficient value at least 10% lower than the haze coefficient value of the intermediate portion, preferably at least 20% lower, and more preferably at least 30% lower.

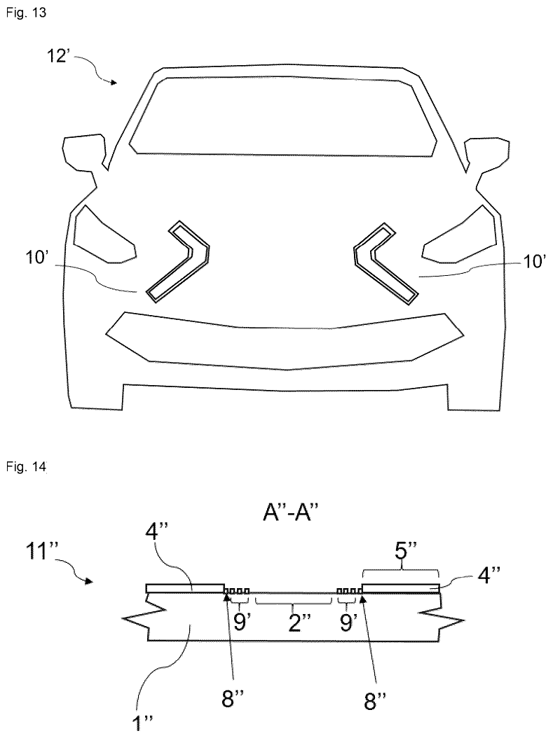

FIG. 13 shows a vehicle 12′ comprising two luminous components 10′ for a motor vehicle. These luminous components 10′ include the vehicle part 11′. One or more light sources, not shown, are located inside the vehicle, opposite each part 11, so as to emit the light that will pass through the transparent or translucent portion 2. The luminous components 10′ form the same elements as the luminous components 10.

In a variant of the method 200, the irradiation step 207 is implemented so as to form a specific pattern or patterns in the intermediate area 9′, for example hatchings, by alternately irradiating this intermediate area 9′. The result is as shown in FIG. 14, which comprises additional apostrophes for each numerical reference corresponding to a similar element in the previous embodiment. The aesthetic effect generated is therefore different.

In a sub-variant not shown, the irradiation step 207 is implemented to generate progressively changing patterns in the intermediate area 9′, between the area 2″ and the painted area 5″. For example, the irradiated hatching becomes increasingly spaced or narrower, starting from the unmasked portion 2″, approaching the painted area 5″. The aesthetic effect generated is therefore different.

In a variant not shown, the polypropylene obtained in step 201 is different from that obtained in the embodiment presented above, in that its transparency and the diffuse nature of the light passing through it will be different. A person skilled in the art will know how to vary the manufacturing characteristics of the material so as to vary the interaction parameters of the material with light. These parameters will therefore also be different for the intermediate portion 9 or 9′.

As an alternative to the methods described, the part body 1 is obtained by molding one of the following materials: polyamide, polyethylene terephthalate, polybutylene terephthalate, polyurethane, polyvinyl chloride, acrylonitrile butadiene styrene, styrene acrylonitrile, acrylonitrile styrene acrylate, polymethyl methacrylate, cycloolefin copolymer or cycloolefin polymer.

Alternatively, the part 11 or 11′ can be integrated into any vehicle exterior component having a main surface, comprising the part 11 or 11′, in particular of a size corresponding to at least twice the size of the surface of the part 11 or 11′, the exterior component forming, for example, a bumper, a grille, a fender, a rear spoiler, a hood or a tailgate panel. In these variants, a portion of the main surface of the component comprises a material that is different from the material of the part.

The invention is not limited to the embodiments presented, and other embodiments will become clearly apparent to a person skilled in the art.

### List of References

1, 1′, 1″: vehicle part body
2, 2′, 2″: masked area-unmasked area-transparent or translucent portion
3: temporary cover
4, 4′, 4″: coat of paint
5, 5′, 5″: painted area-painted portion
6: adhesion primer
7: base coat
8, 8′, 8″: border
9′, 9″: intermediate area-intermediate portion
10, 10′: luminous component
11, 11′: vehicle part
12, 12′: vehicle

1. A method for manufacturing a vehicle part, comprising steps of:
masking a portion of a transparent or translucent vehicle part body, so as to form a masked portion of the part body;
applying a coat of paint to the part body, in an area encompassing all or part of the masked portion, so as to form a painted area;
removing the masking, the masked portion becoming an unmasked, paint-free portion;
irradiating the coat of paint with laser radiation, in a border of the unmasked portion, so as to define a clear paint boundary around the unmasked portion.

2. The method according to claim 1, comprising a step of manufacturing the body of the transparent or translucent part by molding a plastic.

3. The method according to claim 2, wherein the plastic comprises polycarbonate, polyamide, polyethylene terephthalate, polybutylene terephthalate, polyurethane, polyvinyl chloride, acrylonitrile butadiene styrene, styrene acrylonitrile, acrylonitrile styrene acrylate, polymethyl methacrylate, cycloolefin copolymer, or cycloolefin polymer.

4. The method according to claim 2, wherein the plastic is a transparent or translucent polypropylene.

5. The method according to claim 1, wherein the irradiation step further comprises irradiating a portion of the painted area from the clear paint boundary, so as to form an intermediate area located between the unmasked portion and the rest of the painted area.

6. The method according to claim 5, wherein the irradiation step is carried out by hatching to form one or more specific patterns in the intermediate area.

7. The method according to claim 1, wherein:
the masking step comprises placing a temporary covering means,
the step of applying the coat of paint comprises applying an opaque, preferably dark, adhesion primer and applying a base coat in a predetermined shade.

8. A vehicle part obtained by the manufacturing method according to claim 1, comprising:
a transparent or translucent portion formed by the unmasked portion;
a painted portion formed by the painted area.

9. The vehicle part according to claim 8, wherein irradiation step of the manufacturing method further comprises irradiating a portion of the painted area from the clear paint boundary, so as to form an intermediate area located between the unmasked portion and the rest of the painted area, wherein the vehicle part further comprises an intermediate portion formed by the intermediate area, between the transparent or translucent portion and the painted portion.

10. The vehicle part according to claim 9, wherein the transparent or translucent portion has a haze coefficient value at least 10% lower than the haze coefficient value of the intermediate area.

11. The vehicle part according to claim 9, wherein the transparent or translucent portion has a haze coefficient value at least 20% lower than the haze coefficient value of the intermediate area.

12. The vehicle part according to claim 9, wherein the transparent or translucent portion has a haze coefficient value at least 30% lower than the haze coefficient value of the intermediate area.

13. A luminous component for a motor vehicle, comprising the vehicle part according to claim 8 and a light source for illuminating at least part of the transparent or translucent portion of the part.

14. The luminous component according to claim 13, forming one of the following elements:
a daytime running light;
a position light;
a turn signal;
a reversing light;
a headlamp.

15. A motor vehicle comprising at least one of the luminous component according to claim 13.

16. A motor vehicle comprising at least one of the vehicle part according to claim 8.
